(19) United States
(12) Patent Application Publication
(10) Pub. No.: US 2015/0114281 A1
(43) Pub. Date: Apr. 30, 2015

(54) WARNING TRIANGLE

(71) Applicants: Evgeny Arturovich BARTULI, Kolomna (RU); Gennadij MERKUSEV, Kongen (DE)

(72) Inventors: Evgeny Arturovich BARTULI, Kolomna (RU); Gennadij MERKUSEV, Kongen (DE)

(21) Appl. No.: 14/593,140

(22) Filed: Jan. 9, 2015

Related U.S. Application Data
(63) Continuation of application No. PCT/IB2013/001551, filed on Jul. 9, 2013.

(30) Foreign Application Priority Data
Jul. 9, 2012 (RU) 2012128429

(51) Int. Cl. B60Q 7/00; G09F 13/16; G09F 19/22

(52) U.S. Cl. CPC B60Q 7/005; G09F 19/22; G09F 13/16
USPC 116/63 T

(57) ABSTRACT

The triangular warning sign is a tripod forming a pyramid with ribs connected to each other by upper ends and framed by a flexible sheath with light-reflecting flexible strips. The ribs form telescopic legs with a hinged connection to each other. For a fixation of the completely unfolded legs it is provided with a fixing strut. The light-reflecting flexible strips are attached to the legs on two lateral sides and form a red polymer cloth frame. On the front side, rails are attached to the legs by lower portions and connected to each other by their upper ends, at their upper portion the rails are connected to the legs. A flexible polymer cloth strip is attached to the rails, formed as a red frame consisting of an outer light-reflecting band and an inner fluorescent band, surrounding the hollow centre on three sides and having the shape of concentric equilateral triangles.

### CROSS-REFERENCE TO RELATED APPLICATIONS

This application claims benefit of priority to and is a continuation of International Application No. PCT/IB2013/001551, filed Jul. 9, 2013, which is hereby incorporated by reference herein in its entirety, and to Russian Application No. 2012128429 filed on Jul. 9, 2012, which is hereby incorporated by reference herein in its entirety.

### TECHNICAL FIELD

The disclosure relates to road signal technology, particularly to temporary signaling appliances, which may be carried in a vehicle and be placed on a thorough-fare part of a road for signaling in daytime and nighttime the presence of a vehicle that has come to a halt.

### BACKGROUND

A foldable three-dimensional base with traffic signs is known. In its folded-out state the foldable three-dimensional base with traffic signs forms a pyramid with ribs in the shape of rods, connected with each other at least by their upper ends, and with faces in the shape of triangular side walls between the rods. The three-dimensional basis is formed by an flexible sheath and rods connected to the latter, while the traffic signs on the side walls are made of light-reflecting flexible strips attached to them, forming traffic signs of triangular shape for an accidental halt when the three-dimensional basis is in its unfolded state. The foldable three-dimensional base forms a triangular pyramid in its unfolded state. The rods are made of metal or wood. The rods are connected to each other by the upper ends by the flexible sheath or by a wire connector. The flexible sheath is made of cloth or non-cloth material. At the top of the flexible sheath a loop-shaped flexible handle is attached.

This construction is not sufficiently reliable and compact.

The technical result, the achievement f which is the aim of the present disclosure, is a compact, reliable, and safe construction.

### SUMMARY

The technical result may be achieved as follows. A triangular warning sign may be a tripod which in its unfolded state forms a pyramid with ribs connected to each other at least by their upper ends and framed by an flexible sheath formed as light-reflecting flexible strips, which in the unfolded state of the pyramid form traffic signs of a triangular shape.

The ribs form telescopic legs with a hinged connection to each other. The light-reflecting flexible strips are attached to the legs on two lateral sides and form a polymer cloth strip formed as a red frame consisting of an outer light-reflecting band and an inner fluorescent band, surrounding a hollow centre on three sides and having the shape of concentric equilateral triangles. All these features render it possible to reduce the dimensions of the construction in its folded state, giving it the required compactness.

On the front side, rails are attached to the legs which can he bent in a vertical plane and fixed in that position, the rails being attached to the legs by their lower portion, while at their upper portion the rails are connected to the legs by a fixing mechanism. An flexible polymer cloth strip is attached to the rails, formed as a red frame consisting of an outer light-reflecting band and an inner fluorescent band, surrounding the hollow centre on three sides and having the shape of concentric equilateral triangles. All these features make the construction fulfill the safety requirements stipulated for triangular warning sign.

The triangular warning sign may be provided with a fixing strut for a fixation of he completely unfolded legs. Thus the legs can be reliably fixed in their unfolded state.

The foldable tripod may be made of light metal, or polymer, or a combination of light metal and polymer, The legs may be covered with a light porous rubberized material on the outside. This makes the sign lightweight and safe for a vehicle in case of a collision with it. The surface of the legs of the foldable tripod may be covered with a light-reflecting material. This makes the sign more visible and enhances its safety and information value.

The light-reflecting band may be a flexible high-intensive light-reflecting polymer membrane with a cellular (for instance, honeycomb) structure. All these features render it possible to reflect light with the required intensity.

The legs of the foldable tripod may be provided with support stands at their lower portion. All these features render it possible to position the sign reliably when in use.

An example aspect is a tripod triangular warning sign comprising two lateral sides and one front side, wherein the sign in unfolded state is a pyramid comprising ribs connected to each other at least by ribs' upper ends, wherein the ribs are framed by a flexible sheath comprising light-reflecting flexible strips, wherein the pyramid in unfolded state forms at least one triangular traffic sign; wherein the ribs comprise telescopic legs with a hinged connection to each other; a fixing strut for fixation of fully extended legs; wherein the light-reflecting flexible strips are attached to the legs on the two lateral sides of the tripod forming a red polymer cloth frame including an outer light-reflecting band and an inner fluorescent band forming concentric equilateral triangles surrounding a hollow center on three sides; rails tiltably attached to the legs by lower portions on the front side of the tripod and capable of being fixed in a substantially vertical plane substantially perpendicular to a road surface, wherein the rails are connected to each other by their upper ends and connected to the legs at their upper portion by a fixing mechanism; and a flexible polymer cloth strip attached to the rails forming a red frame including of an outer light-reflecting band and an inner fluorescent band forming concentric equilateral triangles surrounding a hollow center on three sides.

In some aspects, the legs are made of a light metal. In some aspects, the legs are made of a polymer. In some aspects, the legs are made of a combination of light metal and polymer. In some aspects, the legs are covered with light porous rubberized material on outside. in some aspects, at least one light-reflecting band is made of a flexible high-intensity light-reflecting polymer membrane with a cellular structure. In some aspects, the legs comprise support plates at their lower portion. in some aspects, the legs are covered with light-reflecting material. In some aspects, the rails comprise axles, the legs comprise semicircular eyes, each eye including an aperture, for inserting the axles. In some aspects, the legs are made of aluminum.

The above simplified summary of example aspects serves to provide a basic understanding of the disclosure. This summary is not an extensive overview of all contemplated aspects of the disclosure, and is intended to neither identify key or critical elements of all aspects nor delineate the scope of any or all aspects. Its sole purpose is to present one or more aspects in a simplified form as a prelude to the more detailed description of the disclosure that follows. To the accomplishment of the foregoing, the one or more aspects comprise the features described and particularly pointed out in the claims.

### BRIEF DESCRIPTION OF THE DRAWINGS

The accompanying drawings, which are incorporated into and constitute a part of this specification, illustrate one or more example aspects of the disclosure and, together with the detailed description serve to explain their principles and implementations.

FIG. 1 illustrates an example triangular warning sign in a general view.

FIG. 2 illustrates the assembly A from FIG. 1.

FIG. 3 illustrates the assembly B from FIG. 1.

FIG. 4 illustrates an example triangular warning sign in its folded state.

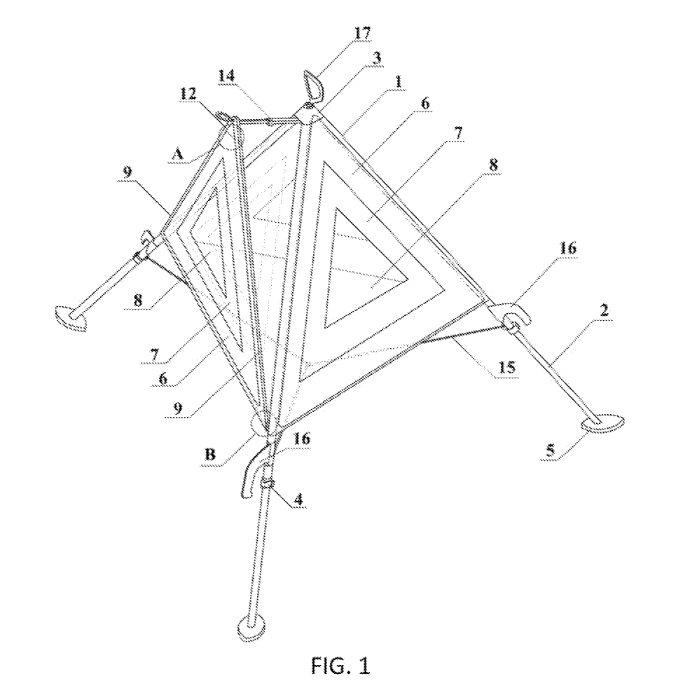

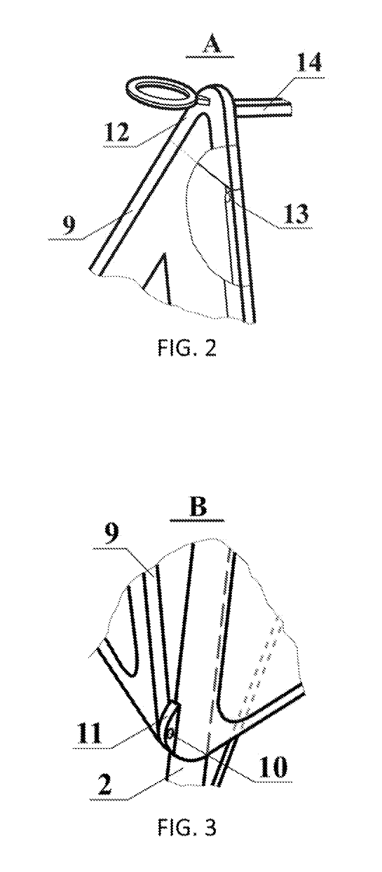

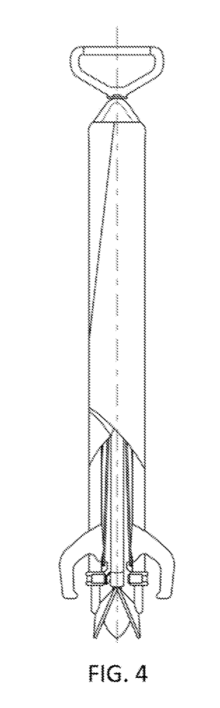

### DETAILED DESCRIPTION

Example aspects of the present disclosure are described herein in the context of a triangular warning sign. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects of the disclosure as illustrated in the accompanying drawings. The same reference indicators will be used to the extent possible throughout the drawings and the following description to refer to the same or like items.

An example triangular warning sign is a foldable tripod 1 comprising legs 2 connected to each other at the upper portion of the construction with a hinge 3. The legs 2 of the tripod form a hollow telescopic construction of several hollow sections connected by a fixing element 4. Various known elements can be used as the fixing element 4 for the sections of the legs 2, for instance, a bayonet joint, an eccentric clamp, a sleeve joint, or a thread joint. At the lower ends of the telescopic legs 2 there are hinged support plates 5. The lower portion of the support plates 5 is formed to provide a reliable contact with the road surface.

To the legs 2 of the tripod 1 an flexible polymer cloth strip is attached in a stationary way to two lateral sides to form a red frame consisting of an outer light-reflecting band 6 and an inner fluorescent band 7 surrounding the hollow centre 8 from three sides. The hollow centre 8, the fluorescent band 7, and the light-reflecting band 6 may be shaped as concentric equilateral triangles.

Rails 9 are attached on the front side of the foldable tripod 1 on the legs 2. The rails 9 are tiltably attached to the legs 2 by their lower portion in a vertical plane perpendicular to the surface of the road. The rails have axles 10, while semicircular hinges 11 having an aperture, into which the axles 10 of the rails 9 are inserted, are formed on the legs 2. The rails 9 are connected to each other by their upper ends by a joint with an inverted-“v”-shaped member, the corner 12 with hinges 13. The corner 12 is connected to the legs 2 by a foldable fixing mechanism 14.

A flexible polymer cloth strip is also attached to the rails 9; it forms a red frame comprising an outer light-reflecting band 6 and an inner fluorescent band 7 surrounding a hollow center 8 from three sides. The hollow center 8, the fluorescent band 7, and the light-reflecting band 6 are shaped as concentric equilateral triangles.

For fixation of fully extended legs of the tripod in operational state, a fixing strut 15 is provided. To ease the folding and unfolding there are handles 16 on the legs.

At the top of the construction there is a gripping handle 17 for moving the item.

The foldable tripod 1 may be manufactured from light metal (for instance, aluminum and magnesium alloys), polymers (for instance: carbon, basalt fiber, polypropylene), or a combination of one and the other. The legs 2 may be covered with light porous rubberized material on the outside. The legs of the foldable tripod may be covered with light-reflecting material. The surface of the legs 2 of the foldable tripod may be covered with light-reflecting material.

The width of the light-reflecting band 6 is 25-50 mm and is substantially the same on all three sides. The light-reflecting band 6 is a flexible high-intensive light-reflecting polymer membrane with a cellular for example, honeycomb) structure. This material has the highest coefficient of light intensity, which significantly exceeds that of other membranes, and the broadest indicatrix.

The minimum area of each of the three sides of the fluorescent band 7 in its operational state is 315 cm². The fluorescent material of the light-reflecting band 7 has a luminosity coefficient, including the luminosity caused by reflection and fluorescence, of at least 30%. The fluorescent material 7 is colored through or forms a coating applied onto the surface of a flexible polymer cloth strip.

The apparatus works as follows.

To render it operational, the legs 2 of the foldable tripod 1 are unfolded with the handles 16, whereby the tripod 1 takes the shape of a triangular pyramid. The rails 9 are thereby also unfolded in their lower portion together with the legs 2. The polymer cloth strip attached to the legs 2 and the rails 9 is stretched and takes the shape of a triangle. The legs are fixed with the fixing struts 15.

In a position of use on the road, the frontal face side of the triangular warning sign must be positioned vertically, perpendicularly to the surface of the road—this is a requirement of GOST R 41.27-2001 (UNECE (United Nations Economic Council for Europe) Regulation R 27). To bring it into that position, the rails 9 are turned away from the legs 2 until they reach a vertical position, which is regulated with the aid of the foldable fixing mechanism 12.

The triangular warning sign can be manufactured with existing tools and equipment.

In the interest of clarity, not all of the routine features of the aspects are shown and described herein. It will be appreciated that in the development of any such actual implementation, numerous implementation-specific decisions must be made in order to achieve the developer's specific goals, and that these specific goals will vary from one implementation to another and from one developer to another. It will be appreciated that such a development effort might be complex and time-consuming, but would nevertheless be a routine undertaking of engineering for those of ordinary skill in the art having the benefit of this disclosure.

Furthermore, it is to be understood that the phraseology or terminology used herein is for the purpose of description and not of limitation, such that the terminology or phraseology of the present specification is to be interpreted by the skilled in the art. in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known components referred to herein by way of illustration. Moreover, while aspects and applications have been shown and described, it would be apparent to those skilled in the art having the benefit of this disclosure that other modifications than those mentioned herein possible without departing from the disclosed concepts.

1. A tripod triangular warning sign comprising:
two lateral sides and one front side,
wherein the sign in unfolded state is a pyramid comprising ribs connected to each other at least by ribs upper ends,
wherein the ribs are framed by a flexible sheath comprising light-reflecting flexible strips,
wherein the pyramid in unfolded state farms at least one triangular traffic sign;
wherein the ribs comprise telescopic legs with a hinged connection to each other;
a fixing strut for fixation of fully extended legs;
wherein the light-reflecting flexible strips are attached to the legs on the two lateral sides of the tripod forming a red polymer cloth frame including an outer light-reflecting band and an inner fluorescent band forming concentric equilateral triangles surrounding a hollow center on three sides;
rails tiltably attached to the legs by lower portions on the front side of the tripod and capable of being fixed in a substantially vertical plane substantially perpendicular to a road surface,
wherein the rails are connected to each other by their upper ends and connected to the legs at their upper portion by a fixing mechanism; and
a flexible polymer cloth strip attached to the rails forming a red frame including of an outer light-reflecting band and an inner fluorescent band forming concentric equilateral triangles surrounding a hollow center on three sides.

2. The triangular warning sign of claim 1, wherein the legs are made of a light metal.

3. The triangular warning sign of claim 1, wherein the legs are made of a polymer.

4. The triangular warning sign of claim 1, wherein the legs are made of a combination of light metal and polymer.

5. The triangular warning sign of claim 1, wherein the legs are covered with light porous rubberized material on outside.

6. The triangular warning sign of claim 1, wherein at least one light-reflecting band is made of a flexible high-intensity light-reflecting polymer membrane with a cellular structure.

7. The triangular warning sign of claim 1, wherein the legs comprise support plates at their lower portion.

8. The triangular warning sign of claim 1, wherein the legs are covered with light-reflecting material.

9. The triangular warning sign of claim 1,
wherein the rails comprise axles, and
wherein the legs comprise semicircular eyes, each eye including an aperture, for inserting the axles.

10. The triangular warning sign of claim 1, wherein the legs are made of aluminum.
